(19) United States
(12) Patent Application Publication
(10) Pub. No.: US 2025/0066121 A1
(43) Pub. Date: Feb. 27, 2025

(54) VARIABLE TEMPERATURE ZONE

(71) Applicant: AutoStore Technology AS, Nedre Vats (NO)

(72) Inventors: Øystein GJERDEVIK, Skjold (NO); Jonas LÆGREID HALDORSEN, Rubbestadneset (NO)

(21) Appl. No.: 18/726,698

(22) PCT Filed: Jan. 3, 2023
(86) PCT No.: PCT/EP2023/050059

§ 371 Date: Jul. 3, 2024

(30) Foreign Application Priority Data
Jan. 7, 2022 (NO) 20220024

(51) Int. Cl. B65G 1/06; B65G 1/04; F25D 13/06

(52) U.S. Cl. CPC B65G 1/065; B65G 1/0478; F25D 13/06

(57) ABSTRACT

A system and method for a variable temperature zone (503, 504, 505, 506, 507) in a storage and retrieval system (1), wherein the storage and retrieval system comprises a framework structure (100) which includes a rail system (108) comprising a first set of parallel rails arranged to guide movement of a container handling vehicle (201, 301, 401) in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, the framework structure comprising upright members (102) defining storage columns (105) for storing containers (106) within the framework structure, wherein the storage and retrieval system comprises at least one container handling vehicle configured to operate on the rail system wherein the different temperature zones are separated by an insulated curtain (501) that can be lowered and raised from the roof and can be moved up and down the length and/or the width of the grid system, and storage containers stacked on top of each other to create an insulating wall in the grid system.

### FIELD OF THE INVENTION

The present invention relates to an automated storage and retrieval system for storage and retrieval of containers, in particular to a system and a method for a storage and retrieval system having different temperature zones with sizes that can be adapted to the number of items in storage.

### BACKGROUND AND PRIOR ART

FIG. 1 discloses a typical prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301,401 comprises a vehicle body 201a,301a,401a and first and second sets of wheels 201b,301b,201c, 301c, 401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c, 301c, 401c is arranged to engage with two adjacent rails of the second set 111 of rails. At least one of the sets of wheels 201b, 301b,201c, 301c, 401b, 401c can be lifted and lowered, so that the first set of wheels 201b, 301b,401b and/or the second set of wheels 201c, 301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

Normally the size of the different temperature zones in a storage and retrieval system if dimensioned to the maximum size that could be needed for that particular storage and retrieval system. This solves the problem with the zones being to small but it is an unnecessary expensive solution since it will cost a lot more than it has to both when it comes to building the storage and retrieval system, but also when it comes to maintaining it and the daily cost of running it.

It is therefore need for a solution that solves the problems mentioned above

### SUMMARY OF THE INVENTION

The present invention is set forth and characterized in the independent claims, while the dependent claims describe other characteristics of the invention.

In one aspect, the invention is related to an automated storage and retrieval system with a reconfigurable temperature zone (701) wherein the automated storage and retrieval system comprises a framework structure which includes a rail system comprising a first set of parallel rails arranged to guide movement of a container handling vehicle in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, the framework structure comprising upright members defining storage columns for storing containers within the framework structure, wherein the automated storage and retrieval system comprises at least one container handling vehicle configured to operate on the rail system, wherein that an upper region of the reconfigurable temperature zone is separated from a remainder of the automated storage and retrieval system by at least one insulated curtain that can be lowered and raised from above and wherein the insulated curtain is arranged to be moved up and down a length and/or a width of the framework structure in the first and second directions (X, Y), and a lower region of the reconfigurable temperature zone is separated from other storage columns of the framework structure by modified storage containers that are stacked on top of each other to create an insulating wall within a row of storage columns in the framework structure.

Further the thermal insulation can be attached to the sides of the storage container in order to create a thermally insulating barrier between the stacked storage containers, the thermal insulation can be a foam material.

The thermal insulation can be sufficiently flexible to seal against thermal insulation provided on a neighbouring storage container.

The brush seals can be attached to sides of the container for engagement with a brush seal on a neighbouring storage container, the brush seals can comprise tightly stacked bristles.

The storage containers can have extendable sides in order to create an insulating barrier between the stacked storage containers and the extendable sides can be arranged to be deployed upon the storage container coming to rest on an underlying floor surface or on an underlying storage container already in a storage column.

Also, the extendable sides can be controlled by a rack and pinion system activated by a spring loaded helical screw connected to the bottom of the storage container.

The storage containers can be loaded with thermal insulation in order to increase the thermal insulating effect of the storage containers.

There can be multiple reconfigurable temperature zones within the automated storage and retrieval system, each comprising an insulated curtain to separate an upper region of the temperature zone and rows of modified storage containers within the framework structure to separate a lower region of the temperature zone from other storage columns within the framework structure.

In a second aspect, the invention concerns a method of providing a reconfigurable temperature zone (701) in an automated storage and retrieval system, wherein the automated storage and retrieval system comprises a framework structure which includes a rail system comprising a first set of parallel rails arranged to guide movement of a container handling vehicle in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, the framework structure comprising upright members defining storage columns for storing containers within the framework structure, wherein the automated storage and retrieval system comprises at least one container handling vehicle configured to operate on the rail system to handle storage containers, and wherein the method comprises the following steps: deciding the size of the reconfigurable temperature zone in the automated storage and retrieval system, instructing the container handling vehicles to start stacking a plurality of modified storage containers in designated positions in the automated storage and retrieval system to build walls of modified storage containers within rows of storage columns of the framework structure, in order to separate a lower region of the reconfigurable temperature zone from other storage columns within the framework structure, and lowering an insulating curtain from a roof of a building containing the automated storage and retrieval system into positions above the rail system corresponding to the positions of the walls of modified storage containers below the rail system. rearranging the modified storage containers and the insulating curtains according to instructions from a computer system in order to reconfigure the temperature zone assessing the needs for temperature zones dynamically based on forecast storage requirements.

The method can be performed for multiple temperature zones which are arranged in different regions of the automated storage and retrieval system.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective figure looking upward of a central cavity container handling vehicle where the lifting platform is visible lowered down underneath the vehicle.

FIG. 5 is a side view of an embodiment of this application wherein a storage and retrieval system are displayed with departments for different temperature zones, and the zones can be of different sizes.

FIG. 6 is a side view of a container with added side features for insulating the different temperature zones from each other.

FIG. 7a is a side view of an alternative solution to a container for insulating the different temperature zones from each other.

FIG. 7b is a top view of the solution presented in 7a.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

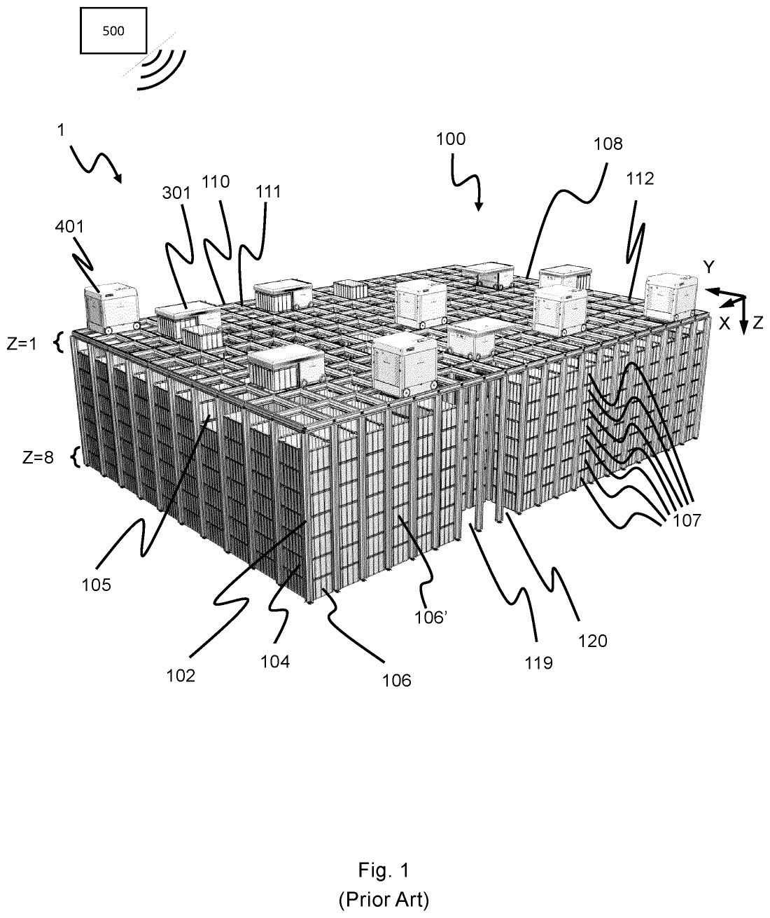

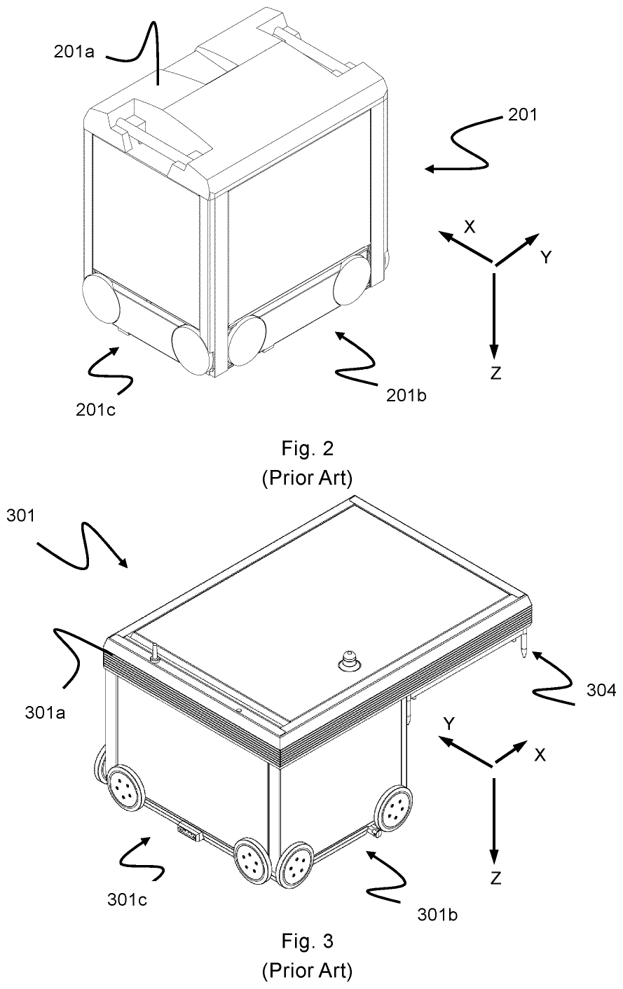

The framework structure 100 of the automated storage and retrieval system 1 is constructed in accordance with the prior art framework structure 100 described above in connection with FIGS. 1-3, i.e. a number of upright members 102 and a number of horizontal members 103, which are supported by the upright members 102, and further that the framework structure 100 comprises a first, upper rail system 108 in the X direction and Y direction.

The framework structure 100 further comprises storage compartments in the form of storage columns 105 provided between the members 102, 103, where storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

The present invention regards a storage and retrieval system with temperature zones that can be adjusted according to the needed size. The size of the different zones can be needed to be adjusted according to factors like seasons or similar.

Normally this is solved by scaling each zone for the maximum need. A better solution would be to adjust the amount of grid used for each zone dynamically. Customers can dynamically allocate the specific need. This results in more cost effective storage system as you don't need to design for maximum need in regard to temperature zones but instead only scale for maximum total size.

A way of adjusting the size of the different zones is to have an insulated curtain that can be raised and lowered and maneuvered back and forth according to need. Further, we could use containers to separate the different zones from each other inside the grid system itself. The containers could be stacked on top of each other in rows.

A problem with using containers is that when they are stacked there is a gap between the containers. Hence the gap between the containers must be closed with either a material attached to the outside of the container or a mechanism that can expand the size of the container when it is staked.

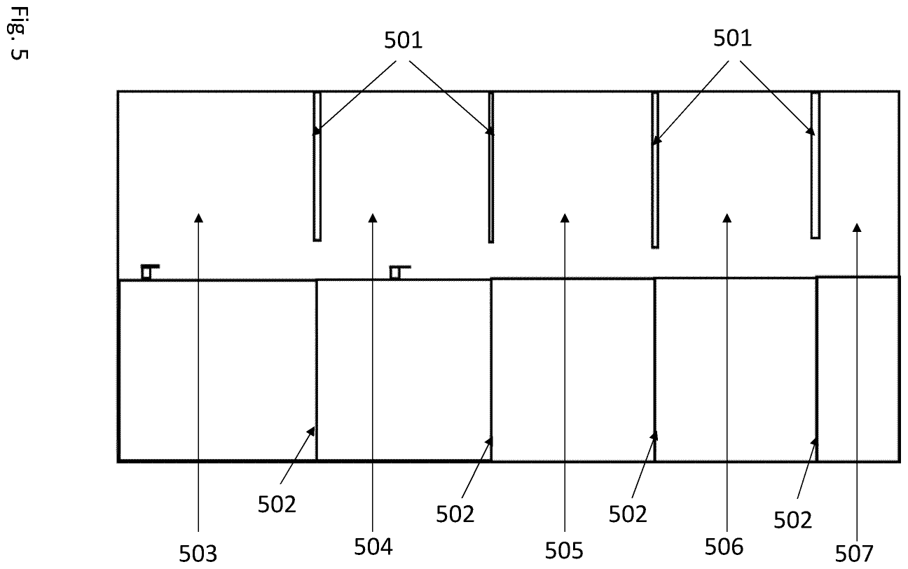

One embodiment of the automated storage and retrieval system according to the invention will now be discussed in more detail with reference to FIGS. 5-7b

FIG. 5 is a side view of an embodiment of this application wherein a storage and retrieval system are displayed with departments for different temperature zones, and the zones can be of different sizes. A temperature zone is a section of the storage and retrieval system that keeps a different temperature than the surrounding areas, sections or zones. Such zones can be e.g. frozen, chilled/frozen, ambient/chilled and/or ambient. The temperature in the individual sections can be set to any degree that is beneficial for storing a certain group of items. The temperature can be set to the recommended temperature for storing items set by the government. The items can be frozen foods, chilled foods, plants, etc.

In this figure we can se a storage and retrieval system where that is divided into several sections 503-507. Each of these sections are separated by a thermally insulated curtain. The thermally insulated curtain can be lowered and raised from above. Further the curtain can be moved up and down a length and/or a width of the framework structure in the first and second directions X and Y. This allows for adapting the size of the section. The curtain can e.g. be moved around by a set of overhead rail systems.

When a section of the storage and retrieval system is to be separated from the rest of the storage and retrieval system there the first thing that needs to be done is to decide how big the section needs to be. The estimate of the size that needs to be sectioned of can be done by a central computer system, the central computer system is the central that keeps track of the position of all the items in the storage and retrieval system, all the orders that are coming in, the movement of every container handling vehicle and many more operations. The size of the section can also be set by an operator. When the size has been determined the insulated curtains are moved in position by e.g. an overhead rail system to insulate the area above the storage and retrieval system. The storage and retrieval system itself are separated from the surrounding sections by stacking containers in rows 502 corresponding to the section of the curtains. This allows for a flexible way of sectioning of parts of the storage and retrieval system.

When the size of a section needs to be changed, the curtains can be moved, and the rows of containers can be lifted and moved to another location.

There can be two rows of containers stacked next to each other in order to increase the insulating effect. By stacking two or more rows of containers next to each air will get trapped between the rows of containers which gives an insulating effect.

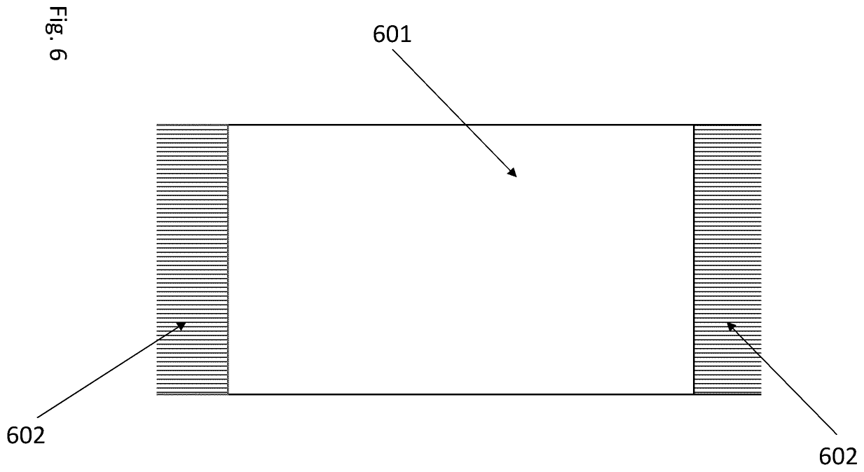

FIG. 6 is a side view of a container with added side features for insulating the different temperature zones from each other.

When the containers are stacked in rows in order to create a wall of containers that stops the air from one side of the barrier to travel to the other side of the barrier there is always a little gap between the columns of containers in order to get them through the opening in the top. This creates a gap that allows air to travel from one side of the barrier to the other side. This gives the barrier of containers a low insulating effect.

In order to solve this, we have to close the gap between the columns of containers. In FIG. 6 this is solved by adding a soft material to the outside of the containers. The soft material will allow the container to be lowered into and lifted from the column. Further the soft material will close the gap between the container and prevent air from traveling from one side of the barrier created by the row of container to the other side.

And if there are two or more rows of containers placed next to each other the insulating effect of the two or more rows of containers are increased.

The soft material can be on all the four sides of the containers (except top and bottom). Alternatively, the containers can have soft material only of the shorter end sides.

The soft material can be a foam material like a sponge or similar or it can be soft dense bristle type material like a brush. The point is that the material is soft enough to deform as it is lowered into and lifted out of the storage column and has the ability to reshape when stacked next to each other.

This embodiment allows the use of ordinary containers to create the barrier between two different temperature zones.

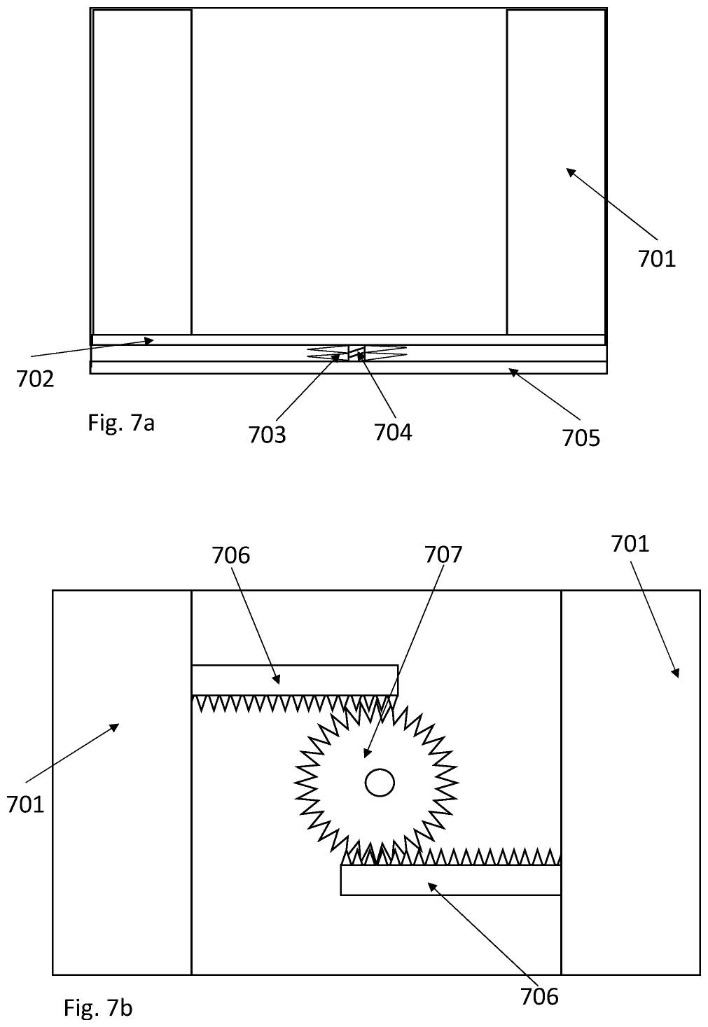

FIGS. 7a and 7b is a side view and a top view of an alternative solution to a container for insulating the different temperature zones from each other.

Here it is presented a different embodiment of the invention. In this embodiment the containers are specially made in order to close the gap between two rows of containers. In this embodiment the containers are made to have the sides expand under its own weight as it is rested on the floor or on the top of another container. The container has an outer bottom and an inner bottom. Between the outer bottom and the inner bottom there is a spring. Further the outer bottom of the container has a spring loaded helical screw attached to it. As the weight of the container increases, the spring is compressed, and the screw turns a gear inside the container. The spring presses against the inner bottom of the container and expands if the container is lifted again. The gear turns and interacts with a set of racks. The rotation of the of the gear pushes on the racks which again expands the sides outwards.

Alternatively, in stead of the gear and the rack, forming a rack and pinion system there can be a central piece that rotates when the weight of the container compresses the spring and the distance between the inner and the outer bottom decreases. To the central piece there is attached a set of rods. These rods are pushed outwards when the central piece is rotated, and the sides of the container is expanded. When the container is lifted again, the spring expands the distance between the inner and the outer bottom and the central piece rotates the other way and the rods are pulled inwards and the sides retracts.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

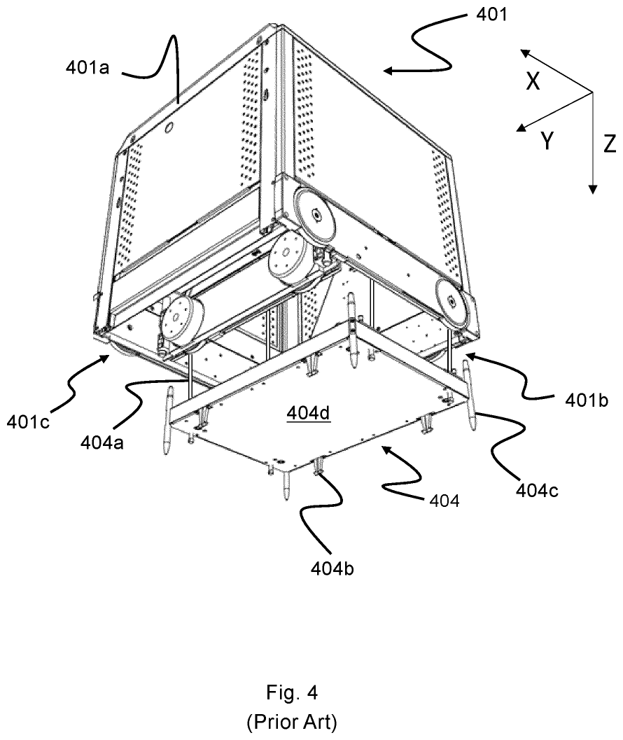

Prior art (FIGS. 1-4):
1 Prior art automated storage and retrieval system
100 Framework structure
102 Upright members of framework structure
103 Horizontal members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art container handling vehicle
201a Vehicle body of the container handling vehicle 201
201b Drive means/wheel arrangement, first direction (X)
201c Drive means/wheel arrangement, second direction (Y)
301 Prior art cantilever container handling vehicle
301a Vehicle body of the container handling vehicle 301
301b Drive means in first direction (X)
301c Drive means in second direction (Y)
401 Prior art container handling vehicle
401a Vehicle body of the container handling vehicle 401
401b Drive means in first direction (X)
Drive means in second direction (Y) 401c
501 Air curtain
502 Stacks of containers separating temperature zones
503 Temperature zone 1
504 Temperature zone 2
505 Temperature zone 3
506 Temperature zone 4
507 Temperature zone 5
601 Storage Container
602 Flexible insulating material
701
Expanding sides of a container
Inner bottom
702
703 Spring
704 Screw
705 Outer bottom of container
706 Rack
707 Gear
X First Direction
Y Second direction
Z Third direction

1. An automated storage and retrieval system with a reconfigurable temperature zone, wherein the automated storage and retrieval system comprises:
a framework structure which includes a rail system comprising a first set of parallel rails arranged to guide movement of a container handling vehicle in a first direction (X) across the top of the framework structure, and a second set of parallel rails arranged perpendicular to the first set of parallel rails to guide movement of the container handling vehicle in a second direction (Y) which is perpendicular to the first direction (X), the first and second sets of parallel rails dividing the rail system into a plurality of grid cells, the framework structure comprising upright members defining storage columns for storing containers within the framework structure, wherein the automated storage and retrieval system comprises at least one container handling vehicle configured to operate on the rail system,
characterized in that an upper region of the reconfigurable temperature zone is separated from a remainder of the automated storage and retrieval system by at least one insulated curtain that can be lowered and raised from above and wherein the insulated curtain is arranged to be moved up and down a length and/or a width of the framework structure in the first and second directions (X,Y), and a lower region of the reconfigurable temperature zone is separated from other storage columns of the framework structure by modified storage containers that are stacked on top of each other to create an insulating wall within a row of storage columns in the framework structure.

2. The automated storage and retrieval system according to claim 1, wherein thermal insulation is attached to sides of a storage container in order to create a thermally insulating barrier between the stacked storage containers.

3. The automated storage and retrieval system according to claim 2, wherein the thermal insulation is a foam material.

4. The automated storage and retrieval system according to claim 3, wherein the thermal insulation is sufficiently flexible to seal against thermal insulation provided on a neighboring storage container.

5. The automated storage and retrieval system according to claim 1, wherein brush seals are attached to sides of a storage container for engagement with a brush seal on a neighboring storage container.

6. The automated storage and retrieval system according to claim 5, wherein the brush seals comprise tightly stacked bristles.

7. The automated storage and retrieval system according to claim 1, wherein the storage containers have extendable sides in order to create an insulating barrier between the stacked storage containers.

8. The automated storage and retrieval system according to claim 7, wherein the extendable sides are arranged to be deployed upon a storage container coming to rest on an underlying floor surface or on an underlying storage container already in a storage column.

9. The automated storage and retrieval system according to claim 8, wherein the extendable sides are configured to be controlled by a rack and pinion system activated by a spring loaded helical screw connected to the bottom of the storage container.

10. The automated storage and retrieval system according to claim 1, wherein the storage containers are loaded with thermal insulation in order to increase a thermal insulating effect of the storage containers.

11. The automated storage and retrieval system according to claim 1, wherein there are multiple reconfigurable temperature zones within the automated storage and retrieval system, each reconfigurable temperature zone comprising the insulated curtain to separate the upper region of the reconfigurable temperature zone and rows of the modified storage containers within the framework structure to separate the lower region of the reconfigurable temperature zone from the other storage columns within the framework structure.

12. A method of providing a reconfigurable temperature zone in an automated storage and retrieval system, wherein the automated storage and retrieval system comprises a framework structure which includes a rail system comprising a first set of parallel rails arranged to guide movement of a container handling vehicle in a first direction (X) across the top of the framework structure, and a second set of parallel rails arranged perpendicular to the first set of parallel rails to guide movement of the container handling vehicle in a second direction (Y) which is perpendicular to the first direction (X), the first and second sets of parallel rails dividing the rail system into a plurality of grid cells, the framework structure comprising upright members defining storage columns for storing containers within the framework structure, wherein the automated storage and retrieval system comprises at least one container handling vehicle configured to operate on the rail system to handle storage containers, and wherein the method comprises the following steps:
deciding a size of the reconfigurable temperature zone in the automated storage and retrieval system;
instructing container handling vehicles to start stacking a plurality of modified storage containers in designated positions in the automated storage and retrieval system to build walls of the modified storage containers within rows of the storage columns of the framework structure, in order to separate a lower region of the reconfigurable temperature zone from other storage columns within the framework structure; and
lowering an insulating curtain from a roof of a building containing the automated storage and retrieval system into positions above the rail system corresponding to the positions of the walls of the modified storage containers below the rail system.

13. The method according to claim 12, wherein the method further comprises:
rearranging the modified storage containers and the insulating curtain according to instructions from a computer system in order to reconfigure the reconfigurable temperature zone.

14. The method according to claim 12, wherein the method further comprises:
assessing a need for reconfigurable temperature zones dynamically based on forecast storage requirements.

15. The method according to claim 12, wherein the method is performed for multiple reconfigurable temperature zones that are arranged in different regions of the automated storage and retrieval system.
